(19) United States
(12) Patent Application Publication
(10) Pub. No.: US 2007/0120283 A1
(43) Pub. Date: May 31, 2007

(54) POLYPROPYLENE FILMS EMPLOYING RECYCLED COMMERCIALLY USED POLYPROPYLENE BASED FILMS AND LABELS

(75) Inventors: Barry Jason Hostetter, Landenberg, PA (US); Philip F. Welch, Terre Haute, IN (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: APPLIED EXTRUSION TECHNOLOGIES, INC., New Castle, DE (US)

(21) Appl. No.: 11/550,611

(22) Filed: Oct. 18, 2006

Related U.S. Application Data
(60) Provisional application No. 60/727,726, filed on Oct. 18, 2005.

(51) Int. Cl. B32B 27/32; B32B 27/18

(52) U.S. Cl. 264/102; 428/411.1; 428/523; 264/140; 264/173.16; 264/911

(57) ABSTRACT

A multilayer film includes a core layer having recycled, commercially used plastic therein and opposed skin layers, at least one of said opposed skin layers including a whitening agent or other pigmenting agent therein to mask any undesired coloration created by the recycled plastic. Laminations employing the above multilayer film also form part of this invention. A method of this invention for making a multilayer film including a core layer with recycled plastic therein includes the steps of: separating a plastic film or label from a package of commercial product; pelletizing the plastic film or label into pellets for introduction into an extruder of a film forming device and introducing the pelletized plastic film or label into said extruder for introducing the recycled plastic film or label pellets into a core layer of a multilayer film.

### RELATED APPLICATION

This utility patent application claims the benefit of U.S. Provisional Patent Application Ser. No. 60/727726, filed Oct. 18, 2005, entitled “Polypropylene Films Employing Recycled Commercially Used Polypropylene Based Films and Labels.”

### BACKGROUND OF THE INVENTION

This invention relates generally to employing recycled, commercially used polypropylene-based material in polypropylene films and more specifically to the use of commercially used flexible packaging and labels as the recycled material employed in polypropylene-based films.

### BACKGROUND ART

It is known to recycle waste material generated in a film-forming extrusion process back into the extruder to thereby effectively use the scrap material in the formation of extruded polypropylene film. For example, scrap material generated in the film-forming process has been introduced into the extruder in a conventional tenter line to thereby incorporate the scrap into the core layer of a multilayer, extruded film, which preferably is biaxially oriented as part of the formation process.

Also, in Su et al. U.S. Pat. No. 5,286,424, it has been disclosed to recycle biaxially oriented polypropylene film coated with a chlorine-containing polymer by separating the chlorine-containing polymer from the olefin prior to reprocessing the olefin into a desired product by extrusion, molding, or other heat-generating product forming process. The use of a biaxially oriented polypropylene film coated with a chlorine-containing polymer, such as polyvinylidene chloride homopolymer and/or copolymer generally are (is) quite expensive to recycle, requiring that the chlorine-containing polymer first be separated from the polyolefin.

Oriented polypropylene (OPP) films, either uniaxially or biaxially oriented, are used in a wide variety of commercial applications, including use as posters, brochures, tags, signs, packaging films, and labels employed on a variety of packaged products, including labels employed on plastic bottles formed of polyethylene terephthalate (PET). Applicant has recognized the significant desirability, from an environmental standpoint, of recycling these commercially used products, after the useful life of the products have ceased, back into polypropylene plastic film structures for subsequent commercial use. However, a number of the above identified commercial films and labels include a variety of additives, including printing inks that would tend to impart an undesired gray visual appearance to films into which such commercial films and labels are recycled.

For example, commercially used PET food and beverage containers employing polypropylene-based labels thereon generally are recycled to recover the PET for subsequent use in other plastic products. As a result of a typical, commercial PET container recycle process, the polypropylene based labels that are separated from the PET plastic containers generally have been disposed of by incineration or by being transported to landfills or are used in low quality molding applications. To applicants' knowledge, there has not been any suggestion to recycle printed and converted polypropylene flexible packaging or labels attached to plastic containers back into in OPP films.

### SUMMARY OF THE INVENTION

Applicant has recognized that oriented polypropylene film (OPP) based flexible packaging and labels can be recycled into opaque OPP plastic films, even though such packaging and label films include inks and adhesives that normally provide an undesired visual appearance to plastic films after they are mixed in the recycle processes.

In the most preferred embodiments of this invention, OPP film based flexible packaging or labels are used as a part of the composition of the core layer of a multilayer opaque OPP film. In the example of OPP film based labels, the labels may be collected as scrap or second quality material subsequent to the label making process or the labels may be separated from plastic bottles, preferably PET bottles, as part of a typical PET container recycle process. For all examples, the OPP film based flexible packaging or labels are ground up and melt extruded into pellets for inclusion into at least the core layer of a multilayer, opaque film.

Converted OPP film based flexible packaging or label stock, either as scrap or recovered from a post consumer recycle process, is recycled into extruded pellets using standard film re-extrusion processing techniques. For example, bales of flexible packaging or label stock are fed into a granulator where large sheets of recycled material are reduced in size to flakes. These flakes are then processed through a densifier to produced compressed pellets of un-melted film. The pellets are fed into an extruder which is equipped with a vacuum vent. Commercial processing aids, such as ML1803, a compound of calcium oxide in polyethylene, which is manufactured by ML Plastics GmbH, may also be used. Finally, the melt is pumped through a fine mesh filter and into a standard underwater pelletizer.

A representative OPP label stock that is recycled in accordance with this invention is a laminate structure including for example, a multilayer voided opaque film such as AET's 400 WT/L II and a multilayer clear film such as AET's 48 B503-2, with the printing ink and the lamination adhesive located between the opaque and the clear films and with the inks being visible through the clear film.

The commercially used single layer or laminated flexible packaging or label structures may consist of clear, opaque, metallized or coated films and may be one or more films in combination.

The formation of the melt extruded pellets can take place either at the site of manufacture of the multilayer, opaque OPP films or at a remote site. Most preferably the resultant multilayer opaque film itself has a wide variety of applications, including use as labels, signs, tags, brochures, posters, etc.

In accordance with this invention a variety of structures and compositions employed in commercial OPP flexible packaging and label applications can be recycled, including structures based on, but not limited to clear, white, metallized or coated films. These flexible packaging and label structures most often include inks, lacquers, coatings, and adhesives which generally have been considered to render them undesirable for use as recycled material in plastic film structures.

An exception to this invention is OPP films employing polyvinylidene chloride homopolymer and/or copolymer coatings. Specifically, polyvinylidene chloride is not compatible with polypropylene-based films into which the plastic labels are intended to be recycled. To remove polyvinylidene chloride from the plastic labels prior to recycling the labels would be undesirably costly and therefore economically not feasible.

The benefits of utilizing post used OPP film based flexible packaging and labels as recycled materials which are part of the composition of a newly produced OPP film are numerous. It is envisioned that the overall economics for a process that utilizes recycled flexible packaging and labels would operate at a reduced material cost compared to utilization of all new materials. The other benefit to use of recycled OPP film based flexible packaging and labels as part of the composition of newly produced OPP films are the environmental benefits from a recycle perspective and enhanced sustainability life cycle.

### DETAILED DESCRIPTION OF THE INVENTION

In accordance with this invention commercially used, flexible packaging and/or labels made from oriented polypropylene films, either uniaxially oriented or biaxially oriented, are collected, converted by melt extrusion into pellets and are introduced into an extruder for incorporation into the core layer of a multilayer, opaque plastic film, either uniaxially oriented or biaxially oriented. The pelletizing operation may take place either at the manufacturing site where the opaque plastic film is extruded, or may take place at a remote site. In this latter case the pellets, after formation, will be transported to the manufacturing site for use in manufacturing the opaque plastic film.

In the most preferred embodiment of this invention the plastic to be recycled is in the form of label stock including inks and/or adhesives thereon, which are attached to commercial packages such as PET bottles. The discussion that follows will be directed to this preferred embodiment.

The oriented films made with the recycled label stock are opaque OPP film structures that can include a single, multilayer, extruded film or a lamination of two or more multilayer, extruded films. The multilayer recycled opaque OPP films can be 2, 3, 5 or more layers produced by coextrusion, extrusion coating, coating, or metallization.

Most preferably each extruded film is a multilayer structure including a voided core and outer opposed skin layers, with the skin layers preferably being substantially thinner than the core layer. Most preferably the recycled label stock, in the form of pellets, is introduced only into the core layer of the multilayer film.

In accordance with the preferred embodiments of this invention, the core layer of the film may be 100% recycled OPP label stock or a blend of between 5-100% recycled OPP label stock combined with virgin or un-recycled polypropylene resin. In the most preferred embodiments the core is voided with any of well known voiding agent, such as calcium carbonate, or one or more of the well known organic voiding agents, such as polybutylene terephthalate. Although the core layer is voided in accordance with the preferred embodiment of this invention, it is within the scope of this invention to form a non-voided core layer with the use of recycled oriented polypropylene label stock. However, it is extremely important that one or more of the outer exposed skin layers include a whitening agent, such as titanium oxide, zinc oxide or barium sulfate, or other pigmenting agent, e.g., carbon black or other coloring agent, to mask any undesired visual effect created by the recycled material.

One or more of the outer, coextruded skin layer(s) preferably is (are) provided by predominantly virgin polypropylene resin and are pigmented, preferably with a white pigment or other coloring agent, to mask the gray color that generally is imparted to the core by the recycled OPP label stock. The resultant multilayer film may be a three or five layer coextruded film and may be coated, extrusion coated or metallized.

It should be understood that when the structures of this invention are laminates of two or more multilayer films, each including one or more outer skin layer(s), it may not be necessary to include either a whitening agent or other pigment in contiguous skin layers to be laminated together. These contiguous skin layers will be internal, or buried layers of the completed film. However, it is very desirable that one or more of the outer exposed skin layers of the multilayer films include a whitening agent or other pigmenting agent so that any undesired color created by the inclusion of the recycled material in the film will be masked.

Most preferably the polymer of the core layer of the multilayer film(s) of this invention is polypropylene, specifically isotactic (crystalline) polypropylene. The term “polypropylene” includes both propylene homopolymers and copolymers of predominately propylene with ethylene or another α-olefin. The preferred copolymers are crystalline random copolymers of propylene and about 1 to 10% ethylene; more preferably about 1 to 6% ethylene and even more preferably about 1 to 4% ethylene. Reference to “propylene homopolymer” includes, in addition to pure homopolymers, mini-random copolymers of propylene including less than 1% ethylene and more preferably 0.6% ethylene. Applicant has recognized by recycling the label structures into an opaque multilayer oriented polypropylene film, the undesired gray color or hue that otherwise would be created by the recycled label stock is avoided. This benefit is most preferably achieved in an opaque multilayer oriented polypropylene film having a voided core and a reasonably heavy loading of titanium dioxide or other whitening agent in one or more of the opposed outer skin layers.

For example, the opposed outer surfaces of the opaque multilayer films of this invention can be coated with an acrylic-clay matte coating; preferably having a thickness of about 8 gauge. This acrylic-clay matte coating provides a surface that is capable of being printed in a variety of ways that can not be employed on uncoated surfaces. Other coatings for improved printing performance may also be used in concert with the present invention.

Converted OPP film based flexible packaging or label stock, either as scrap or recovered from a post consumer recycle process, is recycled into extruded pellets using standard film re-extrusion processing techniques. For example, bales of flexible packaging or label stock are fed into a granulator where large sheets of recycled material are reduced in size to flakes of approximately ⅛ to ¼ in². These flakes are then processed through a densifier to produced compressed pellets of un-melted film. Heat generated in this process is an important first step in reducing the volatiles from the inks and adhesives in the scrap. The pellets are fed into an extruder which is equipped with a vacuum vent and a melt filter. Vacuum venting the extruder is very important to further reduce volatiles from the inks and adhesives as well as moisture and entrained air in the feed. A commercial processing aid called ML1803, a compound of calcium oxide in polyethylene, which is manufactured by ML Plastics GmbH, was fed with the scrap at a 3 wt % level, to aid in reducing the volatiles by chemical reaction. Finally, the melt is pumped through a fine mesh filter and into a standard underwater pelletizer. The final pellets are then dried. Extrusion conditions and standard processing aids are modified as needed to minimize voids within the final pellets. Volatile levels of <0.5% were measured.

The recycled and extruded pellets are added to the core layer through a pre-blended mixture or through the use of an in-line automated blending system which feeds into the core layer of the extruder. The coextruded layers are fed separately and do not contain the recycled extruded pellets

A representative OPP label stock that is recycled in accordance with this invention is a laminate structure including for example, a multilayer voided opaque film such as AET's 400 WT/L II and a multilayer clear film such as AET's 48 B503-2, with the printing ink and the lamination adhesive located between the opaque and the clear films and with the inks being visible through the clear film. The AET films are made by Applied Extrusion Technologies, Inc., having corporate offices in New Castle, Del., U.S.A.

The commercially used single layer or laminated flexible packaging or label structures may consist of clear, opaque, metallized or coated films and may be one or more films in combination.

### EXAMPLE 1

### b 3 Layer Coextrusion

In a representative embodiment of this invention, a three layer opaque film was produced by a typical biaxial orientation tenter process, which is well known. This example includes a core layer comprising 68%, by weight, of a mini random copolymer of polypropylene including 0.6% ethylene; 22%, by weight, of a batch formulation including 62.5% calcium carbonate, 29.4% polypropylene homopolymer and 7.5% titanium dioxide and 10%, by weight, of printed, recycled labels collected as scrap from a label printing and lamination process. This OPP film based label scrap was formed into extruded pellets that were introduced into the barrel of the extruder employed to form the core layer of this example. The recycled pellets also contain 3% ML 1803 manufactured by ML Plastics, which is utilized as a process aid for effective extrusion of printed labels into extruded pellets.

A description of the recycled label extrusion process is detailed as Example 5.

Each of the outer opposed skin layers of this example was 18 gauge and included a master batch identified as WP 814, manufactured by Washington Penn Plastics of Washington, Pa. This WP 814 masterbatch includes 79.9%, by weight, polypropylene mini-random copolymer including 0.6% by weight ethylene therein and 20% titanium dioxide The multilayer opaque film described in this invention was produced by the well known biaxial orientation tenter process. For example, the polypropylene core resin and associated additives were melted and extruded at 250° C. and the coextruded layers were melted and extruded at 210° C. The three layer coextruded melt was extruded through a flat die into a flat sheet at ˜8500 gauge thickness onto a revolving, polished and cooled cast drum at 60° C. The cast sheet was then oriented 5.3 times in the machine direction (MD) using a four roll series machine direction orientation with an orientation temperature of 138° C. and subsequently oriented 10.3 times in the transverse direction in the tenter oven at an oven orientation temperature of 169° C. The film was then surface treated on both sides by corona treatment to a level of 40 dynes.

The resultant film was wound onto a roll. Film properties are listed in Table 1.

All film properties were measured by standard testing methods. The opacity is determined by ASTM D589 and the whiteness index is determined by ASTM E313.

The recycled and extruded pellets were added to the core layer through a pre-blended mixture, which feeds into the core layer of the extruder. The coextruded layers are fed separately and do not contain the recycled extruded pellets

### COMPARATIVE EXAMPLE 2

### 3 Layer Coextrusion

In a comparative example of this invention, a three layer opaque film was produced by the biaxial orientation tenter process. This example includes a core layer comprising 75%, by weight, of a mini random copolymer of polypropylene including 0.6% ethylene and 25%, by weight, of a batch formulation including 62.5% calcium carbonate, 29.4% polypropylene homopolymer and 7.5% titanium dioxide.

Each of the outer opposed skin layers in this example was 18 gauge and included a master batch identified as WP 814, manufactured by Washington Penn Plastics of Washington, Pa. This WP 814 masterbatch includes 79.9%, by weight, polypropylene mini-random copolymer including 0.6% by weight ethylene therein and 20% titanium dioxide.

The multilayer opaque film described in this comparative example was produced by the well known, biaxially orientation tenter process. For example, the polypropylene core resin and associated additives were melted and extruded at 250° C. and the coextruded layers were melted and extruded at 210° C. The three layer coextrusion melt was extruded through a flat die into a flat sheet at ˜8500 gauge thickness onto a revolving, polished and cooled cast drum at 60° C. The cast sheet was then oriented 5.3 times in the machine direction (MD) using a four roll series machine direction orientation with an orientation temperature of 138° C. and subsequently oriented 10.3 times in the transverse direction (TD) in the tenter oven at an oven orientation temperature of 169° C. The film was then surface treated on both sides by corona treatment to a level of 40 dynes. The resultant film was wound onto a roll. Film properties are listed in Table 1.

All film properties were measured by standard testing methods. The opacity is determined by ASTM D589 and the whiteness index is determined by ASTM E313.

This example is representative of a typical oriented white polypropylene film without the use of recycled converted flexible packaging or label structures being utilized in the core composition.

Table of film data for Examples 1 & 2

| | Example 1 | Example 2 |
|---|---|---|
| Thickness (approximate gauge) | 321 | 359 |
| Yield (in2/lb) | 14,688 | 13,612 |
| Density (gm/cc) | 0.59 | 0.57 |
| Tappi Opacity (%) | 98 | 95 |
| Whiteness Index | 67 | 90 |
| Tensile Strength, MD/TD (kpsi) | 8.8/16.7 | 9.2/16.7 |
| Elongation, MD/TD (%) | 93/27 | 113/30 |

### LINE EXAMPLE 3

### Two Ply Lamination

In another representative embodiment of this invention, film from Example 1 was used to produce a two film component lamination structure in combination with AET's 400 WHSL three layer OPP coextruded film. In this example, film from Example 1 was laminated to the non print/non white side of the 400 WHSL film to produce a two film component lamination structure. In this example, one of the outer coextruded layers consists of white pigmented formulations from Example 1 and one white layer is from the 400 WHSL film. The 400 WHSL film is designated as being laminated to the “IN” side of the lamination structure.

AET's 400 WHSL film is a three layer coextruded film with a voided core and a white pigmented print skin. This product is approximately 125 gauge thick, has a yield of 40,000 in2/lb, a density of 0.55, a Tappi opacity of 84 and a whiteness index of 86.

The lamination step is carried out by employing any suitable adhesive, such as an acrylic-based adhesive; such adhesives being well known to those skilled in the art. Thus, in the above-described laminated structure the outer skin layers both include 10% titanium dioxide as the whitening agent to mask the otherwise gray appearance that would be imparted to the film by the recycled label stock.

### EXAMPLE 4

### Three Ply Lamination

In another representative embodiment of this invention, a film from Example 1 was used to produce a three film component lamination structure with two of AET's 400 WHSL three layer OPP coextruded films. In this Example, 400 WHSL was laminated to each side of Example 1 to produce a three film component lamination structure. In this example, both outer coextruded layers consist of white pigmented formulations from the 400 WHSL film. The lamination step is carried out by employing any suitable adhesive, such as an acrylic-based adhesive; such adhesives being well known to those skilled in the art. Thus, in the above-described laminated structure the outer skin layers both include 10% titanium dioxide as the whitening agent to mask the otherwise gray appearance that would be imparted to the film by the recycled label stock.

Table of Lamination data for Examples 3 & 4

| | Example 3 | Example 4 |
|---|---|---|
| Thickness (approximate gauge) | 420 | 540 |
| Yield (in2/lb) | 10,680 | 8,155 |
| Density (gm/cc) | 0.62 | 0.63 |
| Tappi Opacity (%) | 97 | 98 |
| Whiteness Index, In/Out | 84/67 | 85/85 |

### EXAMPLE 5

### Description of Recycled Label to Extruded Pellet Process

Converted OPP label stock was recycled using standard film re-extrusion processing techniques. Bales of label stock, as described above, were fed into a granulator where large sheets of stock are reduced in size to flakes of approximately ⅛ to ¼ in². These flakes were then processed through a densifier to produced compressed pellets of un-melted film. Heat generated in this process is an important first step in reducing the volatiles from the inks and adhesives in the scrap. The pellets were fed into an extruder which was equipped with a vacuum vent and a melt filter. Vacuum venting the extruder is very important to further reduce volatiles from the inks and adhesives as well as moisture and entrained air in the feed. A commercial processing aid called ML1803, a compound of calcium oxide in polyethylene, which is manufactured by ML Plastics GmbH, was fed with the scrap at a 3 wt % level, to aid in reducing the volatiles by chemical reaction. Finally, the melt was pumped through a fine mesh filter and into a standard underwater pelletizer. The final pellets are then dried. Extrusion conditions were modified as needed to minimize voids within the final pellets. Volatile levels of <0.5% were measured.

A representative OPP label stock that was recycled in this example was a laminate structure including a multilayer voided OPP opaque film which was AET's 400 WT/L II and a multilayer OPP clear film which was AET's 48 B503-2, with the printing ink and laminating adhesive being between the opaque and the clear films and with the ink being visible through the clear film.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A multilayer film includes a core layer having recycled, commercially used plastic therein and opposed skin layers, at least one of said opposed skin layers including a whitening agent or other pigmenting agent therein to mask any undesired coloration created by the recycled plastic.

2. The multilayer film of claim 1, including three or more layers produced with coextrusion, extrusion coating, coating or metallization.

3. A single multilayer film or laminations of films with one or more films containing recycled oriented polypropylene films.

4. The multilayer film of claim 1, wherein the recycled plastic is plastic label stock including printing inks therein.

5. The multilayer film of claim 4, wherein the recycled plastic label stock is predominantly polypropylene.

6. The multilayer film of claim 1, wherein said film is predominantly polypropylene.

7. The multilayer film of claim 1, wherein outer, visible skin layers include a whitening agent or other pigmenting agent therein.

8. A method of making a multilayer film including a core layer with recycled plastic therein, said method including the steps of:
a. separating a plastic film or label from a package or commercial product;
b. pelletizing the plastic film or label into pellets for introduction into an extruder of a film forming device;
c. introducing the pelletized plastic film or label into said extruder for introducing the recycled plastic film or label pellets into a core layer of a multilayer film.

9. The method of claim 8, wherein the step of pelletizing the plastic film or label takes place at the facility including the extruder.

10. The method of claim 8, wherein the step of pelletizing the plastic film or label takes place at a location remote from the extruder, including the additional step of transporting said pellets to the facility including the extruder.

11. The method of claim 8, wherein said package is a PET bottle, further including the step of recycling the PET of the bottle for use in other plastic products

12. A lamination of plastics films comprising two or more films, one of said films being the multilayer film of claim 1 and another of said films comprising a commercial plastic film.

13. The multilayer film of claim 1, wherein said film is an opaque film including a voiding agent in the core layer and a white pigment additive in one or more outer layers.

14. The multilayer film of claim 13 where the voiding agent in the core layer is calcium carbonate or polybutylene terephthalate and the outer layer whitening agent is titanium dioxide.

15. The multilayer film of claim 1, wherein said commercially used, recycled plastic is recycled flexible packaging or label stock.

16. The multilayer film of claim 15 where the recycled flexible packaging or label stock utilized a vacuum vent extruder and/or contains a processing aid such as calcium oxide.

17. The process of claim 8 wherein the step of palletizing the recycled flexible packaging or label stock includes the step of utilizing a vacuum vent extruder.

18. The process of claim 8 wherein the step of palletizing the recycled flexible packaging or label stock includes the step of utilizing a processing aid.

19. The process of claim 18, wherein the processing aid includes calcium oxide.
